(19) United States
(12) Patent Application Publication
(10) Pub. No.: US 2008/0282317 A1
(43) Pub. Date: Nov. 13, 2008

(54) METHOD AND APPARATUS FOR CONVERTING A LICENSE

(75) Inventor: Su-hyun NAM, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/947,921

(22) Filed: Nov. 30, 2007

(30) Foreign Application Priority Data
May 11, 2007 (KR) 10-2007-0046211

(51) Int. Cl. G06F 21/00

(52) U.S. Cl. 726/1

(57) ABSTRACT

A method of converting a license is provided. The method includes obtaining a domain policy from a domain to which content is to be transmitted, determining whether license information that is information for a content usage limitation and the domain policy coincide, and then based on the determination result, selectively converting a license.

### CROSS-REFERENCE TO RELATED PATENT APPLICATION

This application claims priority from Korean Patent Application No. 10-2007-0046211, filed on May 11, 2007, in the Korean Intellectual Property Office, the disclosure of which is incorporated herein in its entirety by reference.

### BACKGROUND OF THE INVENTION

1. Field of the Invention

The methods and apparatuses consistent with the present invention relate to converting a license.

2. Description of the Related Art

As the use of home networks becomes more widespread, there is an increasing demand for a system capable of enabling all devices in a house to be registered in one domain, and contents to be commonly used in the respective devices which belong to the domain.

Generally, a home domain system is maintained and managed by domain policies of respective domains. The domain policies include the number of devices capable of being registered to the domain, an information maintenance period in the domain, and available usage functions in the domain.

When a contents provider provides content to a domain, a license containing information for a content usage limitation, is also provided along with the content to the domain. In this case, it is necessary to confirm whether the license information, and a policy of a domain to which the content is to be supplied, coincide. Without this confirmation procedure, a problem may occur.

For example, a problem may occur in the case where a license of content is set to allow content reproduction, content copy, and content transmission whereas a policy of a domain to which the content is to be provided, is set to allow only content reproduction. In other words, the license information of the content and the domain policy conflict, thereby making the content, which has been supplied by a contents provider, unusable. Also, another problem may occur in the case where a license format and a domain policy format are different.

For example, when a license uses an abbreviation form, such as “D:5” to mean an available usage period is five days, a domain policy can use a full-text form, such as “Contents can be used for five days”. In the aforementioned case, a domain may not recognize the meaning of “D:5” denoted by the license as the abbreviation form. Thus, the domain may restrict content usage since the content license cannot be confirmed.

In this way, there are problems caused by conflict between the content license information and the policy of the domain to which the content is to be supplied, or by the difference between the license format and the domain policy format, thereby restricting the usage of the content.

### SUMMARY OF THE INVENTION

The present invention provides a method and apparatus for converting a license to provide content which can be used in respective domains having various domain policies.

According to an aspect of the present invention, there is provided a method of converting a license, the method including: obtaining a domain policy from a domain to which content is to be transmitted; determining whether license information that is information for a content usage limitation, and the domain policy coincide; and selectively converting a license, based on the determination result.

The method may further include transmitting the content and the license to the domain.

The method may further include that obtaining the domain policy may include the operations of transmitting a domain policy request signal requesting transmission of the domain policy, to the domain; and receiving the domain policy from the domain.

The method may further include that determining the coincidence between the license information and the domain policy may further include the operations of determining whether a format of the license and a format of the domain policy coincide; and converting the license format according to the domain policy format, if the license format and the domain policy format do not coincide.

The method may further include that determining the coincidence between the license information and the domain policy may include comparing a license identifier, which is classified according to the license information, with a domain policy identifier, which is classified according to the domain policy, and determine whether the license identifier and the domain policy identifier coincidence.

The method may further include that the license identifier and the domain policy identifier may include at least one of an identification, a version, and a method of protecting the content.

The method may further include that the license may further include a domain policy list including at least one of a domain policy allowed by the license and a domain policy prohibited by the license, and determining the coincidence between the license information and the domain policy may include determining the coincidence, based on the domain policy list.

The method may further include that determining the coincidence between the license information and the domain policy may include determining that the license information and the domain policy do not coincide, when the domain policy is not included in the domain policy allowed by the license, or is included in the domain policy prohibited by the license.

The method may further include determining whether a method of protecting the content in the domain and a current method of protecting the content are the same; and selectively converting the current method of protecting the content into the method of protecting the content in the domain, based on the determination result.

The method may further include that the license may include usage information containing information for functions allowed in using the content, and limitation information containing information for a limitation of the allowed functions.

The method may further include that the transmitting the content and the license may include encrypting at least one of the license and the content with a predetermined encryption key, and transmitting at least one of the encrypted content and the encrypted license.

According to another aspect of the present invention, there is provided a license converting apparatus, the apparatus including: a policy obtainment unit which obtains a domain policy from a domain to which content is to be transmitted; a determination unit which determines whether license information containing information for a content usage limitation, and the domain policy coincide; and a conversion unit which selectively converts the license, based on the determination result.

The license converting apparatus may further include a transmission unit which transmits the content and the license to the domain.

According to another aspect of the present invention, there is provided a computer readable recording medium having recorded thereon a program for executing a license conversion method including obtaining a domain policy from a domain to which content is to be transmitted; determining whether license information containing information for a content usage limitation, and the domain policy coincide; and selectively converting a license, based on the determination result.

### BRIEF DESCRIPTION OF THE DRAWINGS

The above and other features of the present invention will become more apparent by describing in detail exemplary embodiments thereof with reference to the attached drawings in which:

FIG. 1 is a diagram illustrating a license converting apparatus according to an exemplary embodiment of the present invention;

FIG. 2 is a flowchart illustrating a method of converting a license according to an exemplary embodiment of the present invention; and

FIG. 3 is a flowchart illustrating a method of converting a license according to another exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

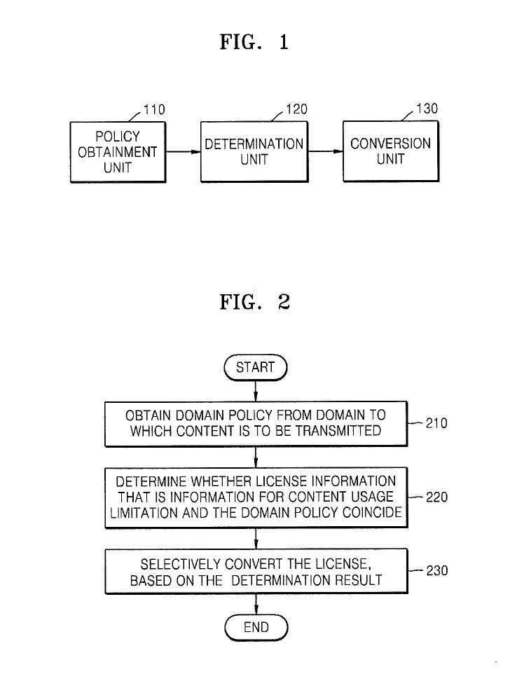

FIG. 1 is a diagram illustrating a license converting apparatus according to an exemplary embodiment of the present invention.

The license converting apparatus according to an exemplary embodiment of the present invention comprises a policy obtainment unit 110, a determination unit 120, and a conversion unit 130.

The policy obtainment unit 110 obtains a domain policy from a domain to which content is to be transmitted.

The domain may be formed of a plurality of devices, and the respective devices may have different policies.

For example, in order to obtain the domain policy, the policy obtainment unit 110 may transmit to the domain, a domain policy request signal requesting a transmission of the domain policy, and then receive from the domain, the domain policy as a response corresponding to the domain policy request signal.

The license converting apparatus according to an exemplary embodiment of the present invention may further include a transmission unit (not shown) for transmitting the domain policy request signal to the domain.

The determination unit 120 determines whether license information containing information for a content usage limitation, and a domain policy coincide.

The license information includes usage information containing information for functions allowed in using content, and limitation information containing information for a limitation of the allowed functions. For example, the usage information may be information informing that only a content reproduction function is allowed among the content reproduction function, a content copy function, and a content transmission function, and the limitation information may be information informing that the content reproduction is allowed to be performed only five times.

At this time, a license format and a domain policy format may be different. In this case, the determination unit 120 determines whether the license format and the domain policy format coincide. If the formats do not coincide, the conversion unit 130 to be described later, converts the license format according to the domain policy format. The determination unit 120 compares information of the license having the converted format with the domain policy.

Meanwhile, the determination unit 120 may compare a license identifier with a domain policy identifier which are generated and classified according to the license information and the domain policy, and then may determine whether they coincide.

The license identifier and the domain policy identifier may be denoted by using an identification (ID), a version, or a method of protecting contents.

For example, the ID of a license may be set as an “A” when the license allows only content reproduction, may be set as a “B” when the license allows content reproduction, and content copy, and may be set as a “C” when the license allows content reproduction, content copy, and content transmission.

Also, in the case where the ID of the license is “A”, the ID may be set as “version 1” when the content reproduction is allowed to be performed only one time, may be set as “version 1.5” when the content reproduction is allowed to be performed three times, and may be set as “version 2” when there is no limit in the number of times the content can be reproduced. In this case, types of the respective licenses may be classified into “ID A|version 1”, “ID A|version 1.5”, and “ID A|version 2”.

Also, the license identifier may be classified according to which digital rights management (DRM) method is used to protect content. For example, in the case where the license having “ID A|version 1” is protected by a DRM “X” method, the license identifier may be generated to be “ID A|version 1|DRM X”.

The aforementioned method of denoting the identifier may identically apply to the domain policy identifier. For example, in the current embodiment, license information with an ID “A” and a domain policy with an ID “A” may have information informing that the ID “A” allows only content reproduction.

Hence, in the above example, since the ID “A” that is the license identifier, and the ID “A” that is the domain identifier are the same, the determination unit 120 may determine that the license information and the domain policy coincide.

Also, based on a domain policy list that is the list of domain policies allowed/prohibited by the license, the determination unit 120 may determine whether the license information and the domain policy coincide. The domain policy list may be included in the license.

At this time, when the policy of the domain to which content is to be transmitted, is not included in the domain policy allowed by the license, or is included in the domain policy prohibited by the license, the determination unit 120 determines that the license information and the domain policy do not coincide.

For example, a domain policy list included in a license includes domain policies allowed/prohibited by the license. The allowed domain policy includes domain policies with IDs “A” and “B”, and the prohibited domain policy includes a domain policy with an ID “C”.

In the case where an attempt is made to transmit content to a domain including domain policies with IDs “A” and “B”, since the domain policies with the IDs “A” and “B” are allowed by the license, the determination unit 120 determines that the license information and the domain policy coincide

On the other hand, in the case where an attempt is made to transmit content to a domain including a domain policy with an ID “C”, since the domain policy with the ID “C” is prohibited by the license, the determination unit 120 determines that the license information and the domain policy do not coincide.

Meanwhile, the domain policies included in the domain policy list may be classified not only by the ID but also by the version. For example, although the domain policy with the ID “C” is included in the prohibited domain policy, a domain policy with “ID C|version 1” may be included in the allowed domain policy.

The conversion unit 130 selectively converts the license, based on a determination result of the determination unit 120.

In other words, according to the determination result of the determination unit 120, when the license information and the domain policy are determined not to coincide, the conversion unit 130 converts the license according to the domain policy.

For example, in the case where a license is set to allow content reproduction, content copy, and content transmission, but a domain policy is set to allow only content reproduction and content copy, the conversion unit 130 may convert the license into a license which allows only content reproduction, and content copy.

Also, in the case where a license is set to allow content to be reproduced five times whereas a domain policy is set to allow content to be reproduced only three times, the conversion unit 130 may convert the license into a license which allows content to be reproduced only three times.

However, in the case where a license is set to allow only content reproduction whereas a domain policy is set to allow content reproduction and content copy, the conversion unit 130 does not convert the license since content is only reproduced according to the license, although the domain policy allows the content reproduction and the content copy.

Meanwhile, according to a result of the determination unit 120 determining coincidence between a method of protecting content in a domain and a current method of protecting content, when the method of protecting the content in the domain and the current method of protecting the content are different, the conversion unit 130 converts the current method of protecting the content into the method of protecting the content in the domain.

In this way, after converting the current method of protecting the content into the method of protecting the content in the domain, when the converted content is transmitted to the domain, it is not necessary to convert the protection method of the content separately in the domain. Therefore, the content received by the domain can be conveniently used in the domain.

However, content may be transmitted to the domain, without converting the content protection method. In this case, the domain directly converts the protection method of the received content into the protection method used in the domain.

In this way, the content and the license are transmitted to the domain by the aforementioned transmission unit (not shown). At this time, at least one of the content and the license may be encrypted with a predetermined encryption key, and then transmitted, so as to prevent the content and the license from being altered by a third party during transmission. Also, in the case where the content and the license are encrypted with a private key, and then transmitted, the encryption may be used to recognize a user.

FIG. 2 is a flowchart illustrating a method of converting a license according to an exemplary embodiment of the present invention.

In operation 210, a domain policy is obtained from a domain to which content is to be transmitted.

In operation 220, it is determined whether license information that is information for a content usage limitation, and the domain policy coincide.

In operation 230, based on the determination result, the license is selectively converted.

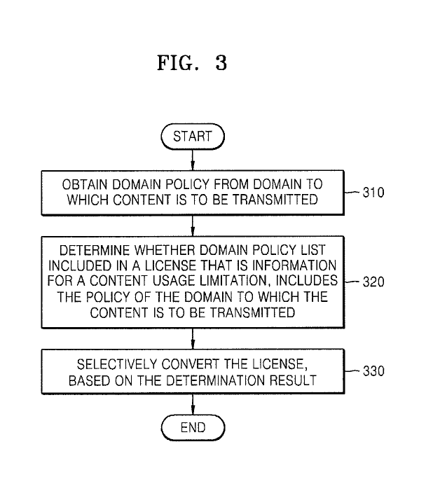

FIG. 3 is a flowchart illustrating a method of converting a license according to another embodiment of the present invention.

In operation 310, a domain policy is obtained from a domain to which content is to be transmitted.

In operation 320, it is determined whether a domain policy list included in a license that is information for a content usage limitation, includes the policy of the domain to which the content is to be transmitted.

The domain policy list includes at least one of a domain policy allowed by the license and a domain policy prohibited by the license. Also, whether the policy of the domain to which the content is to be transmitted, is included in the domain policy list, may be determined according to whether an ID of the domain to which the content is to be transmitted, is included in the domain policy list.

In operation 330, based on the determination result, the license is selectively converted.

In other words, in the case where the policy of the domain to which the content is to be transmitted, is not included in the domain policy allowed by the license or is included in the domain policy prohibited by the license, the conversion unit 130 converts the license according to the policy of the domain to which the content is to be transmitted.

The present invention can obtain the domain policy from the domain to which the content is to be transmitted, determine whether the license information that is the information for the content usage limitation and the domain policy coincide, and then based on the determination result, selectively convert a license, so as to provide content which can be used in respective domains having various domain policies.

The exemplary embodiments of the present invention can be written as computer programs and can be implemented in general-use digital computers that execute the programs using a computer readable recording medium. Examples of the computer readable recording medium include, but are not limited to magnetic storage media (e.g., ROM, floppy disks, hard disks, etc.), optical recording media (e.g., CD-ROMs, or DVDs), and storage media.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of converting a license, the method comprising:
obtaining a domain policy from a domain to which content is to be transmitted;
determining whether license information containing information for a content usage limitation, and the domain policy coincide to generate a first determination result; and
selectively converting a license, based on the first determination result.

2. The method of claim 1, further comprising transmitting the content and the license to the domain.

3. The method of claim 1, wherein the obtaining of the domain policy comprises:
transmitting to the domain, a domain policy request signal requesting transmission of the domain policy; and
receiving the domain policy from the domain.

4. The method of claim 1, wherein the determining comprises:
determining whether a format of the license and a format of the domain policy coincide; and
wherein if the format of the license and the format of the domain policy do not coincide,
converting the format of the license according to the format of the domain policy.

5. The method of claim 1, wherein the determining comprises comparing a license identifier, which is classified according to the license information, with a domain policy identifier, which is classified according to the domain policy, and determining whether the license identifier and the domain policy identifier coincide.

6. The method of claim 5, wherein the license identifier and the domain policy identifier each comprises at least one of an identification, a version, and a method of protecting the content.

7. The method of claim 1, wherein:
the license further comprises a domain policy list comprising at least one of a domain policy allowed by the license and a domain policy prohibited by the license; and
the determining is based on the domain policy list.

8. The method of claim 7, wherein if the domain policy is not comprised in the domain policy allowed by the license, or is comprised in the domain policy prohibited by the license, the determining comprises determining that the license information and the domain policy do not coincide.

9. The method of claim 1, further comprising:
determining whether a method of protecting the content in the domain and a current method of protecting the content are the same and to generate a second determination result; and
selectively converting the current method of protecting the content into the method of protecting the content in the domain, based on the second determination result.

10. The method of claim 1, wherein the license comprises usage information containing information for functions allowed in using the content, and limitation information containing information for a limitation of the functions allowed.

11. The method of claim 2, wherein the transmitting of the content and the license comprises encrypting at least one of the license and the content with a predetermined encryption key, and transmitting at least one of the encrypted content and the encrypted license.

12. A license converting apparatus, the apparatus comprising:
a policy obtainment unit which obtains a domain policy from a domain to which content is to be transmitted;
a determination unit which determines whether license information containing information for a content usage limitation, and the domain policy coincide to generate a first determination result; and
a conversion unit which selectively converts the license, based on the first determination result.

13. The license converting apparatus of claim 12, further comprising a transmission unit which transmits the content and the license to the domain.

14. The license converting apparatus of claim 13, wherein the transmission unit transmits to the domain, a domain policy request signal requesting transmission of the domain policy, and then receives from the domain, the domain policy as a response corresponding to the domain policy request signal, thereby obtaining the domain policy.

15. The license converting apparatus of claim 12, wherein:
the determination unit determines whether a format of the license and a format of the domain policy coincide; and
wherein if the format of the license and the format of the domain policy do not coincide,
the conversion unit converts the format of the license according to the format of the domain policy.

16. The license converting apparatus of claim 12, wherein the determination unit compares a license identifier, which is classified according to the license information, with a domain policy identifier, which is classified according to the domain policy, and determines whether the license identifier and the domain policy identifier coincide.

17. The license converting apparatus of claim 16, wherein the license identifier and the domain policy identifier each comprises at least one of an identification, a version, and a method of protecting the content.

18. The license converting apparatus of claim 12, wherein:
the license further comprises a domain policy list comprising at least one of a domain policy allowed by the license and a domain policy prohibited by the license; and
the determination unit determines the coincidence between the license information and the domain policy, based on the domain policy list.

19. The license converting apparatus of claim 18, wherein if the domain policy is not comprised in the domain policy allowed by the license, or is comprised in the domain policy prohibited by the license, the determination unit determines that the license information and the domain policy do not coincide.

20. The license converting apparatus of claim 12, wherein:
the determination unit determines whether a method of protecting the content in the domain and a current method of protecting the content are the same to generate a second determination result; and
the conversion unit selectively converts the current method of protecting the content into the method of protecting the content in the domain, based on the second determination result.

21. The license converting apparatus of claim 12, wherein the license comprises usage information that is information for functions allowed in using the content, and limitation information that is information for a limitation of the functions allowed.

22. The license converting apparatus of claim 13, wherein the transmission unit encrypts at least one of the license and the content with a predetermined encryption key, and transmits at least one of the encrypted content and the encrypted license.

23. A computer readable recording medium having recorded thereon a program for executing a method of converting a license, the method comprising:
obtaining a domain policy from a domain to which content is to be transmitted;
determining whether license information containing information for a content usage limitation, and the domain policy coincide to generate a first determination result; and
selectively converting a license, based on the first determination result.
